(19) United States
(12) Patent Application Publication
(10) Pub. No.: US 2004/0094260 A1
(43) Pub. Date: May 20, 2004

(54) Ceramic powder transfer process

(76) Inventor: Martin Raymond Summerfield, Stoke-On-Trent (GB)

Correspondence Address: MARTIN RAYMOND SUMMERFIELD, 2 THE QUADRANGLE, ENDON, STOKE-ON-TRENT, GB

(21) Appl. No.: 10/295,054

(22) Filed: Nov. 15, 2002

(51) Int. Cl. B44C 1/165; B41M 3/12; B32B 31/00

(52) U.S. Cl. 156/230; 156/240; 156/247; 156/277; 156/289; 427/146; 156/62.2

(57) ABSTRACT

A process and system for printing images or text and transferring the printed image to a ceramic, glass or metal substrate, by means of a computer controlled inkjet printer spraying a water based ink onto the surface of water slide transfer paper to thereby form an adherent image area. Subsequent deposit of ceramic thermographic colour powder from an interchangeable cartridge, which allows alternative colours to be applied to the adherent image area, and includes the four colour set of cyan, magenta, yellow and black or any other ceramic colour that is required to reproduce the indicia including metals such as gold, silver or platinum which corresponds to the appropriate col separation being printed onto the waterslide transfer paper, the powder adheres to the adherent image area, excess colour is removed and returned to a storage vessel, the waterslide paper is then passed through the printer again to apply the next colour and so on until the required number of colours required has been achieved, a binding agent is coated over the top of the print to create the water slide off transfer or decal.

The present invention relates to process and system for printing images or text and transferring the printed images or text to a ceramic or glass substrate.

### BACKGROUND OF THE INVENTION

The decoration of wares such as ceramic, glass, or china with text or images such as patterns or pictures is widely practiced and the well established and accepted method of decorating such objects is to form decals on water-slide paper. Water-slide paper has a layer of water soluble coating which, upon contact with water becomes sticky and also dissolves. Thus, a decal is formed by printing the pattern or text onto the water-slide paper, which is then wetted to release the printed pattern which can then be transferred onto the object and fixed, usually by firing.

In forming a decal on water-slide paper the typical technique used is to screen print the pattern or picture onto the paper. Using this method a separate screen needs to be developed for each colour in the picture. The process of developing screens is expensive and therefore usually only economically viable for relatively large runs of prints. The cost of developing the screens is prohibitive for a one off printing job. Nevertheless there are many instances where a single object may need to be decorated for example with a photo or words specific to a particular timing of an event in a persons life, such as a fiftieth birthday for example.

Dunford et al. in U.S. Pat. No. 6,110,632 have attempted to overcome some of the problems associated with existing printing techniques by providing a method of transferring an image using coloured ceramic thermographic powder and photostatic or photoelectric printing. Thus, using printing techniques that are presently used in photocopiers and laser printers, the proposed method involves transferring coloured powder photostatically or photoelectrically onto water-slide paper and then transferring the decals thus formed using standard techniques. This process does allow for one off printing however it requires the development of special powders (toners) or inks and it is also costly to set up in that it either requires modification of existing photocopiers to fix the powders or inks used. Alternatively the process requires purchase of a new machine specifically adapted for that purpose. For this reason the technique is not readily applicable to general or non-commercial use because the majority of households do not have a photocopier available and especially not one to be modified as required.

There is therefore a need for a process and system for producing decals that is relatively inexpensive to set up and allows for ready printing of one off decals.

### OBJECT OF THE INVENTION

The object of this invention is to provide a ceramic powder transfer process that obviates or alleviates any one of the above problems, or at least to provide the public with a useful choice.

### SUMMARY OF THE INVENTION

For the purposes of this specification the word “comprising” means “including but not limited to”, and the word “comprises” has a corresponding meaning.

Also a reference within this specification to a document is not to be taken as an admission that the disclosure therein constitutes common general knowledge in The United States of America.

In one form, but not necessarily the broadest or only form, of a first aspect the invention could be said to reside in a process for transferring indicia onto a ceramic or glass substrate, the process including the steps of:

digitising an image of the indicia,

using a computer controlled printer to print the indicia using a liquid medium onto paper having a removable backing to thereby form an adherent image area corresponding to said indicia,

depositing coloured powder onto the paper such that the powder adheres to the paper in the areas corresponding to the adherent image area,

removing any excess non-adhered coloured powder from the surface of the paper,

applying a binding means to bind the adhered coloured powder in place to form a decal, and

removing the backing and transferring the indicia onto the substrate.

Preferably the indicia is also fixed onto the substrate after it has been transferred thereto. Fixing could be chemical fixing, or by heating the substrate. Thus in the case of ceramic substrate the deposited image can be kiln-fired onto the substrate. In the present context a ceramic or glass substrate is to be defined broadly to encompass, ceramic, earthenware, bone china, glass, glass or ceramic tiles, glass ceramic, vitreous enameled metals, metals, and other surfaces suitable for firing with ceramic powders.

In one preferred form the paper is a water slide off paper having a water soluble coating. In this way after the coloured powder has been bound, the coating dissolves in water releasing the bound colour in a thin flexible layer that can be transferred to substrate.

It will be appreciated that the printer can be any printer that is capable of printing a wet image onto paper. For example many brands of inkjet or inkjet type printers such as bubblejet printers are commercially available and are suitable. The inkjet printer may have one or more inkjet cartridges that spray aqueous solution onto the paper. The aqueous solution may be water based ink that prints a wet image onto the paper. Dry coloured powder particles can then be dusted over the wet image area so that the particles selectively adhere only to the image area.

The computer for controlling the inkjet printer may be a software package running on a personal computer or other micro-processor. Thus, the image may be digitally stored and then transferred onto the paper using an inkjet printer. This has the advantage that the digitally stored image can be manipulated electronically before being printed. Thus using this technology it is easy to make small changes to an image and then print and transfer. This is to be contrasted to the current widely used Offset Litho and Screen Process printing techniques, wherein conventional PrePress techniques are required, such as the production of a negative or positive film to make a new screen or printing plate every time a change is required in the image. This also has benefits for the environment in that it reduces the need for processing of film, printing plates, screens etc and its associated materials, chemicals and energy etc.

The coloured powder may be any suitable powder. In one preferred form the powder is a thermographic powder that can be thermographically bonded to a ceramic or glass substrate, and includes coloured ceramic powders. The thermographic powder is preferably coloured and preferably at least the four colour set of magenta, cyan, yellow and black are available. In this way different colours may be formed by mixing appropriately coloured powders according to the CYMK scales. Each colour may be deposited as separate layers either manually by hand or according to instructions from the computer. Thus an area to be coloured yellow may be wetted and then yellow powder deposited. The process is then repeated for other colours to build up colours on paper. The printing technique may use a stochastic pattern which is a random

dotshape which reduces the effect of moiré patterning. This enables dots of different colours to print side by side and to overlap each other.

The coloured powder may be stored in a storage vessel such as a cartridge and may be delivered onto the paper using a suitable delivery hose and nozzle or by a vibrating container allowing the powder to fall evenly onto the paper.

Removal of excess non-adhered coloured powder may be effected by using suction, by vibrating the paper to slide the excess powder off, by blowing the excess powder off, or any combination of these. The printer may be adapted to provide one of these functions. In a preferred form the excess non-adhered coloured powder is removed by suction and is recirculated back into a storage vessel containing the powder.

Once the coloured powder is deposited on the wet image area and the excess non-adhered thermographic powder has been removed the image can be bound in place by overcoating to thereby form a decal. The image may be overcoated with a cover coat solution which upon baking burns away without leaving any residue. Suitable cover coat solutions are commercially available. In this form the decal may be stored for later transfer to an appropriate substrate.

Thus, in a preferred form, the invention may be a process for transferring digital images onto a ceramic or glass substrate comprising the steps of the first aspect of the invention wherein the computer and associated software store, process and print the images.

Advantages of the present process are that it is cheap to set up principally because it utilises technology and hardware components that are easily accessible and affordable. Thus the technology such as software and hardware (scanners etc) required to produce the digital image are well known and are affordable. The software and hardware required to print images using inkjet printers are also commonplace and affordable.

In a second aspect the invention could be said to reside in a system for transferring indicia onto a ceramic substrate, the system including

means for digitising an image of the indicia

inkjet printing means for transferring liquid ink medium onto paper having a removable backing,

the printing means being controlled by a computer so that ink is deposited onto the paper to form an adherent image area corresponding to the indicia,

means for depositing coloured powder onto said paper such that the powder adheres to the adherent image area,

means for removing any excess non-adhered coloured powder from the surface of the paper,

means for binding the adhered coloured powder in place to form a decal suitable for transfer onto the substrate.

In a third aspect the invention could be said to reside in a method for forming a decal suitable from transferring indicia to a substrate, the method including the steps of:

digitising an image of the indicia,

using a computer controlled printer to print the indicia using a liquid medium onto paper having a removable backing to thereby form an adherent image area corresponding to said indicia,

depositing coloured powder onto the paper such that the powder adheres to the paper in the areas corresponding to the adherent image area,

removing any excess non-adhered coloured powder from the surface of the paper, and

applying a binding means to bind the adhered coloured powder in place to form a decal.

In a fourth aspect the invention could be said to reside in a decal formed by the method of the third aspect of the invention.

In a fifth aspect the invention could be said to reside in a printing cartridge containing coloured powder and adapted for use in system of the second aspect of the invention.

A single cartridge may contain a single colour powder or alternatively each colour powder may be housed in separate compartments in the same cartridge.

In a sixth aspect the invention could be said to reside in a printer containing a printer cartridge of the fifth aspect of the invention and adapted for printing onto paper having a removable backing according to the first to third aspects of the invention.

### BRIEF DESCRIPTION OF THE DRAWINGS

For a better understanding the invention will now be described with reference to an illustrated embodiment. The drawings describe an illustrated embodiment wherein,

FIG. 1 is a schematic drawing depicting the process of the present invention.

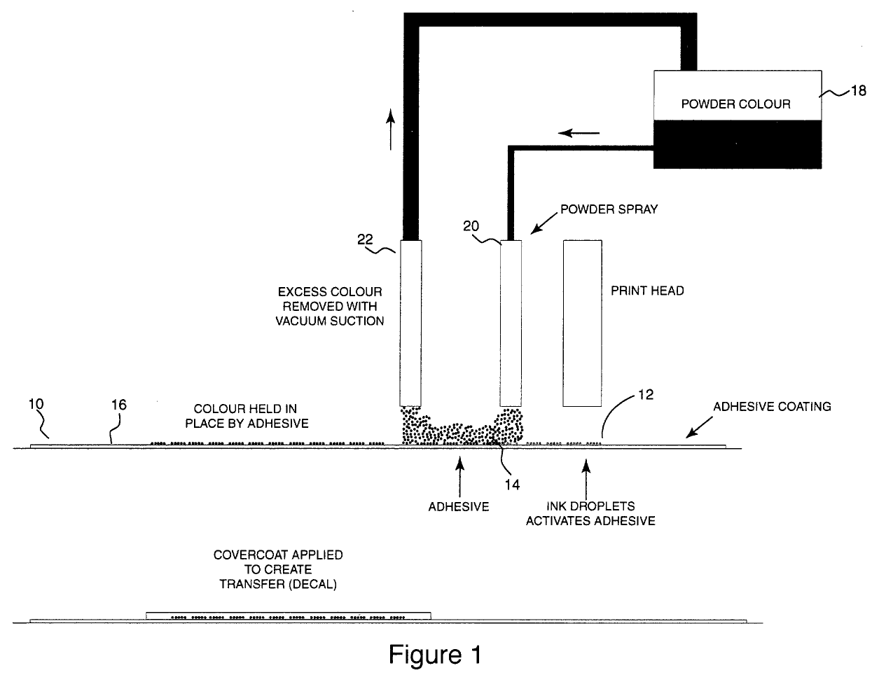

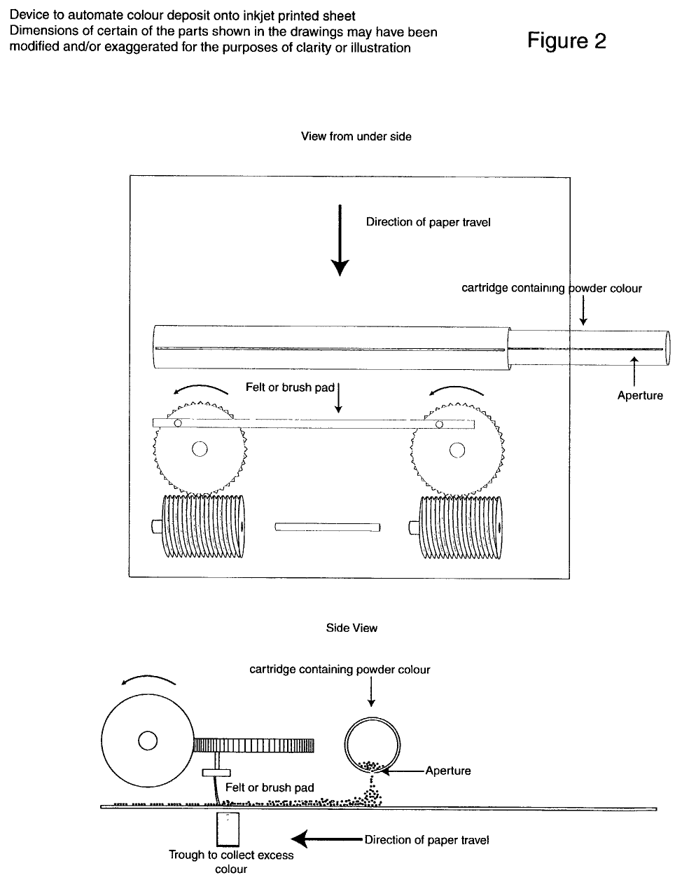

### DETAILED DESCRIPTION OF PREFERRED EMBODIMENTS

Dimensions of certain of the parts shown in the drawings may have been modified and/or exaggerated for the purposes of clarity or illustration.

Disclosed is a process for transferring indicia onto a ceramic or glass substrate. The first step of the process involves digitising the image. A computer controlled printer is then used to print the indicia onto paper having a removable backing, such as water slide-off type decal paper (10) using a liquid ink (12). In this way a wet image area corresponding to the indicia is formed on the paper. Next, coloured powder (14) is deposited onto the paper such that the powder adheres to the paper in the areas corresponding to the adherent image area. Any excess non-adhered powder is then removed from the surface of the paper and the adhered powder is bound in place to form a decal. The removable backing can then be removed and the indicia transferred to the substrate.

The paper may be any suitable paper having a removable backing. In practice one suitable type of paper is found to be water slide off type decal paper which has a layer of water soluble coating which, upon contact with water dissolves to release the image from the surface of the paper. Suitable water-slide papers are commercially available and are typically used for screen printing of decals. For example water-slide papers in the form of paper carriers coated with gum arabic are found suitable as when the paper is moistened with water the gum arabic dissolves releasing the cover coated image, the carrier paper is removed so that the printed image with attached ceramic colour can be slid onto a ceramic or glass substrate. Suitable paper is sold under the trade name Twincal III™ and is available from Tullis Russell Ivy House Paper Mills, Stoke-on-Trent, England.

The coloured powder (14) is preferably a thermographic powder that is a combination of a ceramic pigment and glass frit. Suitable inorganic ceramic pigments include, but are not necessarily limited to, those referred to in “Classification and Chemical Description of the Complex Inorganic Pigments: Third Ed., 1991, Dry Colour Manufacturers' Association publ., Alexandria, Va., USA. Reference may also be had to U.S. Pat. No. 6,110,632 for disclosure of ceramic powders suitable for use in the present invention.

The glass frit chosen for use in the thermographic powder may be selected on the basis of the substrate material onto which the image is to be fired so as to bind the colour. The softening point of the frit and thermal expansion and composition may be selected based on the knowledge of the those skilled in the art and the softening point is preferably in the range 750 to 900° C. which are typical on-glaze enamelling temperatures for decoration on china and earthenware.

The printer chosen may be any commercially available printer that utilises liquid ink as the printing medium. In the illustrated embodiment the printer is an inkjet printer that prints aqueous based inks. Typically the standard inks contain drying agents to assist in drying of the ink in contact with the printing surface. In the present case it may be beneficial to remove the drying agent so that the image remains wet for long enough for the coloured powder to adhere to the image. Typical fixant drying agents are esters or resin-based drying agents.

Details of inkjet printers suitable for use with the present invention can be found in “Output Hardcopy Devices”, Robert C. Durdeck (ed.), Academic Press, 1998. In addition, Weintraub in U.S. Pat. No. 5,627,578 discloses methods for using ink-jet printers to transfer ink onto a paper substrate to form a wet image area after which thermographic powder may be applied in order to build up the image. The process disclosed by Weintraub is used for forming raised lettering or images on paper and especially for printing Braille. The process is only suitable for use with paper and cannot be used for forming images on ceramic articles and especially non-planar ceramic articles.

The coloured thermographic powder may be stored in a cartridge (18) having a delivery nozzle (20) adapted to deliver the powder onto the surface of the paper. The thermographic powder may be gravity fed out through the nozzle. The nozzle may also contain an electronically operated valve that when open allows powder to flow out through the nozzle and stops the flow when it is closed. Operation of the valve may be computer controlled and thus the printing with wet ink onto the water slide paper as well as the delivery of thermographic powder can be automated or semi-automated. Each colour of thermographic powder may be stored in a separate cartridge or alternatively in separate compartments within the same cartridge. The cartridges may be interchangeable and available commercially in the same way ink jet cartridges are available and interchangeable.

In order to recirculate any unadhered thermographic powder a suction means (22) may be in fluid connection with the cartridge so that excess unadhered thermographic powder is removed from the paper surface and re-deposited into the cartridge. The suction means may be in the form of an electrically operated vacuum pump having an inlet that is connected to an intake nozzle which is suspended above the surface of the paper. For example, a small compressor or industrial vacuum cleaner may be modified so that a small nozzle can be attached to the rear of the print head so that it draws up the non adhered colour.

Alternatively the wet ink printed page that exits the inkjet printer may feed directly into a separate ceramic powder dusting unit in which the paper may move on a conveyor under a dusting element that deposits ceramic powder onto the surface. The paper may then pass to a vibratory plate or table wherein excess non-adhered thermographic powder is removed from the paper surface. The excess powder may fall into a collection trough beneath the vibratory table and be recirculated into a thermographic powder storage vessel.

Alternatively the image may be printed using an ink that is a suspension of the coloured ceramic powder in an a liquid ink. In this way the indicia may be printed onto the paper and the liquid ink after drying would be cover coated to thereby leave the ceramic powder deposited on the paper in the form of the indicia.

The computer for controlling the inkjet printer may be a software package running on a personal computer or other micro-processor. Thus, the image may be digitally stored and then transferred onto the wet-slide paper using the inkjet printer. This has the advantage that the digitally stored image can be manipulated electronically before being printed. Thus using this technology it is easy to make small changes to an image and then print and transfer. This is to be contrasted to the current widely used Offset Litho and Screen Process printing techniques, wherein conventional PrePress techniques are required, such as the production of a negative or positive film to make a new screen or printing plate every time a change is required in the image. This also has benefits for the environment in that it reduces the need for processing of film, printing plates, screens etc and its associated materials, chemicals and energy etc.

The process can be used for transferring photographs that have been scanned into a computer. Similarly text prepared on computer can be transferred using the process.

Alternatively art work produced on a graphics software package could be transferred.

### EXAMPLE 1

An image in the form of a photograph is digitised in the usual way using a digital colour scanner and stored in the memory of a personal computer.

At this stage the digitised image can be altered if necessary by colour grading and/or rastering using a software package such as Adobe Photoshop™ for example.

The digitized image is then printed onto a sheet of water-slide paper and the appropriate coloured thermographic powder is poured over the adherent image area. Excess thermographic powder is removed by suction or by vibrating the paper. The print is then coated with a covercoat solution which holds the powder particles in place. The print is then soaked in water to remove the adhesive coating and release the flexible transfer or decal which can be slid off the paper base and applied to a surface. The ceramic article is then fired in a kiln in a conventional manner.

Various features of the invention have been particularly shown and described in connection with the exemplified embodiments of the invention, however, it must be understood that these particular arrangements merely illustrate and that the invention is not limited thereto and can include various modifications falling within the spirit and scope of the invention.

What I claim as my invention is:

1. A process for transferring indicia onto a ceramic or glass substrate, the process including the steps of:
digitizing an image of the indicia,
using a computer controlled printer to print the indicia using a liquid medium onto paper having a removable backing to thereby form an adherent image area corresponding to said indicia,
depositing colored powder onto the paper such that the powder adheres to the paper in the areas corresponding to the adherent image area,
removing any excess non-adhered colored powder from the surface of the paper,
applying a binding means to bind the adhered colored powder in place to form a decal, and
removing the backing and transferring the indicia onto the substrate.

2. Preferably the indicia is also fixed onto the substrate after it has been transferred thereto

3. Fixing could be chemical fixing, or by heating the substrate.

4. Thus in the case of ceramic substrate the deposited image can be kiln-fired onto the substrate.

5. In one preferred form the paper is a water slide off paper having a water soluble coating.

6. A digital printing process as claimed in claim 1 where the printing device is an inkjet printer.

7. The computer for controlling the inkjet printer may be a software package running on a personal computer or other micro-processor thus, the image may be digitally stored and then transferred onto the paper using an inkjet printer as stated in claim 1.

8. In one preferred form the powder is a thermographic powder that can be thermographically bonded to a ceramic or glass substrate, and includes coloured ceramic powders.

9. The thermographic powder is preferably colored and preferably at least the four color set of magenta, cyan, yellow and black.

10. Each color may be deposited as separate layers either manually by hand or according to instructions from the computer, thus an area to be colored yellow may be wetted and then yellow powder deposited the process is then repeated for other colors to build up colors on paper.

11. The printing technique may use a stochastic pattern which is a random dotshape which reduces the effect of moiré patterning. This enables dots of different colors to print side by side and to overlap each other.

12. The colored powder may be stored in a storage vessel such as a cartridge and may be delivered onto the paper using a suitable delivery hose and nozzle or by a vibrating container allowing the powder to fall evenly onto the paper.

13 Removal of excess non-adhered colored powder may be effected by using suction, by vibrating the paper to slide the excess powder off, by blowing the excess powder off, or any combination of these.

14 In a preferred form the excess non-adhered colored powder is removed by suction and is recirculated back into a storage vessel containing the powder.

15 Once the colored powder is deposited on the wet image area and the excess non-adhered thermographic powder has been removed the image can be bound in place by overcoating to thereby form a decal.

16 Thus, in a preferred form, the invention may be a process for transferring digital images onto a ceramic or glass substrate comprising the steps of the first aspect of the invention wherein the computer and associated software store, process and print the images.

17 A system for transferring indicia onto a ceramic substrate, the system including:
means for digitizing an image of the indicia,
inkjet printing means for transferring liquid ink medium onto paper having a removable backing,
the printing means being controlled by a computer so that ink is deposited onto the paper to form an adherent image area corresponding to the indicia;
means for depositing colored powder onto said paper such that the powder adheres to the adherent image area;
means for removing any excess non-adhered colored powder from the surface of the paper, and
means for binding the adhered colored powder in place to form a decal suitable for transfer onto the substrate.

18 A method for forming a decal suitable for transferring indicia to a substrate, the method including the steps of:
digitizing an image of the indicia;
using a computer controlled printer to print the indicia using a liquid medium onto paper having a removable backing to thereby form an adherent image area corresponding to said indicia;
depositing colored powder onto the paper such that the powder adheres to the paper in the areas corresponding to the adherent image area;
removing any excess non-adhered colored powder from the surface of the paper, and
applying a binding means to bind the adhered colored powder in place to form a decal.

19 A decal formed by the method stated in claim 18.

20 A printing cartridge containing colored powder and adapted for use in system as stated in claim 17.

21 A single cartridge may contain a single color powder or alternatively each color powder may be housed in separate compartments in the same cartridge as stated in claim 20.

22 A printer containing a printer cartridge as stated in claim 21 and adapted for printing onto paper having a removable backing according to claim 1 to 18.
